(19) United States
(12) Patent Application Publication
(10) Pub. No.: US 2010/0204834 A1
(43) Pub. Date: Aug. 12, 2010

(54) LIFESTYLE ACTIVITY CHOICE COMFORT SETTINGS

(76) Inventors: Timothy N. Comerford, Indianapolis, IN (US); Shannie Van Ostrand, Indianapolis, IN (US)

Correspondence Address: MARJAMA MULDOON BLASIAK & SULLIVAN LLP, 250 SOUTH CLINTON STREET, SUITE 300, SYRACUSE, NY, 13202, US

(21) Appl. No.: 12/526,902

(22) PCT Filed: Feb. 13, 2007
(86) PCT No.: PCT/US07/03944

§ 371 Date: Jan. 8, 2010

(51) Int. Cl. G05D 23/19

(52) U.S. Cl. 700/276

(57) ABSTRACT

A thermostat includes a present lifestyle activity comfort level corresponding to each of at least three thermostat user interface buttons. The thermostat user interface buttons can be preset using a “radio preset” style of setting. A method of selecting a comfort level includes the step of presetting user operable buttons labeled with a lifestyle activity comfort choice to a comfort level choice using a “radio preset” style of presetting. Also, a thermostat for controlling the comfort level in a building space includes a receiver coupled to a microcomputer, wherein the receiver reacts responsively to a signal indicating the presence of a person in the building space such that on detection of the presence of the person by the receiver, the thermostat sets a comfort level preferred by that person according to a preset comfort level.

### FIELD OF THE INVENTION

This invention relates generally to thermostats that control HVAC systems and more particularly to thermostats offering preset modes of operation.

### BACKGROUND OF THE INVENTION

Thermostats serve as the primary user interface to most heating, ventilation and air conditioning (HVAC) systems, also known as comfort systems. By the end of the twenty first century, older electro-mechanical bi-metallic thermostats had largely been replaced by electronic thermostats. Today, many electronic thermostats have an added a clock function and the capability to program a temperature setpoint to take effect at certain times of day. More advanced programmable thermostats allow a user to program several setpoint temperatures at particular times on any given day, usually by day of the week. It is also common for thermostats to allow for a separate programmed setpoint routine for weekdays and for weekend days. Such programming flexibility has found appeal both in home and commercial settings.

With increasing processing capabilities in ever shrinking physical package sizes, the user programmable options have become so vast in many cases, that what was once a simple dial thermostat has virtually evolved into an electronic instrument that many users find daunting and too difficult to program. In fact much of the potential energy savings once thought to be gained by providing increased programmable thermostat complexity has been lost, as many users can not, or simply do not, effectively program their thermostats. In fact, many owner/users of the most advanced modern thermostats only use them in a most basic manual mode. In such manual modes, any energy savings that might have been gained by use of an advanced thermostat is lost. Therefore, other than energy savings that can be attributed to improved efficiency of the underlying HVAC plant, operational efficiency becomes equivalent to a system controlled by an old electro-mechanical dial thermostat.

Another problem is that people “on the go” with busy lives and lifestyles, often forget to adjust a thermostat when leaving or entering a home, office, or other occupied space.

Therefore there is a need for a thermostat with a user interface that can afford energy efficient thermostat operation without requiring complex programming and multiple button presses in operation. What is also needed a thermostat that can react to the presence of an individual and set that individual's preferred comfort level without requiring manual operation of buttons located on the thermostat by the individual.

### SUMMARY OF THE INVENTION

In one aspect, the invention relates to a thermostat for controlling a HVAC system including at least one microcomputer. The thermostat also includes an interface circuit, the interface circuit electrically coupled to the microcomputer, and the interface circuit also electrically coupled to a HVAC system. The thermostat also includes a display, the display electrically coupled to the microcomputer, and the display to indicate a plurality of comfort settings. The thermostat also includes at least three thermostat user interface buttons, the at least three thermostat user interface buttons electrically coupled to the at least one microprocessor, wherein the at least one microcomputer is programmed to accept a preset lifestyle activity comfort level corresponding to each of the at least three thermostat user interface buttons, and each of the at least three user interface thermostat buttons are labeled with a corresponding lifestyle activity comfort choice label. Also, wherein the preset lifestyle activity comfort level corresponding to each of the at least three thermostat user interface buttons is accomplished using a “radio preset” style of setting, and operation of any one of the at least three user interface thermostat buttons causes the HVAC system to provide the preset lifestyle activity comfort level of the corresponding lifestyle activity comfort choice label.

In yet another aspect, the invention relates to a method of selecting a comfort level includes the steps of: providing a thermostat having at least three user operable buttons, the user operable buttons labeled with a lifestyle activity comfort choice, each button corresponding to a lifestyle activity comfort choice label; presetting at least one time, each of the user operable buttons labeled with a lifestyle activity comfort choice to a comfort level choice using a “radio preset” style of presetting; selecting one of the user operable buttons labeled with a lifestyle activity comfort choice to operate to recall a preset comfort level choice corresponding to a present lifestyle activity choice; and performing again the step of selecting one of the user operable buttons labeled with a lifestyle activity comfort choice to operate when another of the preset comfort level choices better corresponds to a present lifestyle activity choice, wherein the selection is made directly by reference to one of the lifestyle activity comfort choice labels.

In yet another aspect, the invention relates to a thermostat for controlling a comfort level in a building space including at least one microcomputer. The thermostat also includes an interface circuit, the interface circuit electrically coupled to the microcomputer, the interface circuit also electrically coupled to a HVAC system. The thermostat also includes a display, the display electrically coupled to the microcomputer, the display to indicate a plurality of comfort settings. Also, The thermostat includes a receiver coupled to the microcomputer, wherein the receiver reacts responsively to a signal indicating the presence of a person in the building space such that on detection of the presence of the person by the receiver, the thermostat sets a comfort level preferred by the person according to a preset comfort level.

### BRIEF DESCRIPTION OF THE DRAWINGS

For a further understanding of these drawings and objects of the invention, reference will be made to the following detailed description of the invention which is to be read in connection with the accompanying drawing, where:

FIG. 1 shows a simplified block diagram of a thermostat according to one embodiment of the invention;

FIG. 2 shows a thermostat according to one embodiment of the invention;

FIG. 3 shows a view of the thermostat of FIG. 2 with the front cover open;

FIG. 4 shows a programmable thermostat according to another embodiment of the invention;

FIG. 5 shows a view of the thermostat of FIG. 4 with the front cover open.

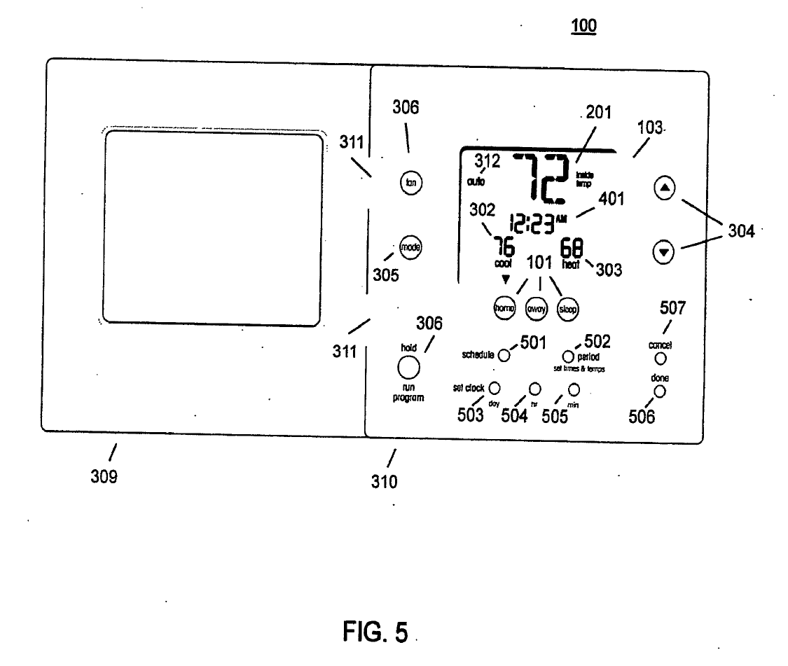

FIG. 6 shows a thermostat controlled by an individual's car key remote; and

FIG. 7 shows a thermostat controlled by an individual's cell phone.

The drawings are not necessarily to scale, emphasis instead generally being placed upon illustrating the principles of the invention. In the drawings, like numerals are used to indicate like parts throughout the various views.

### DETAILED DESCRIPTION OF THE INVENTION

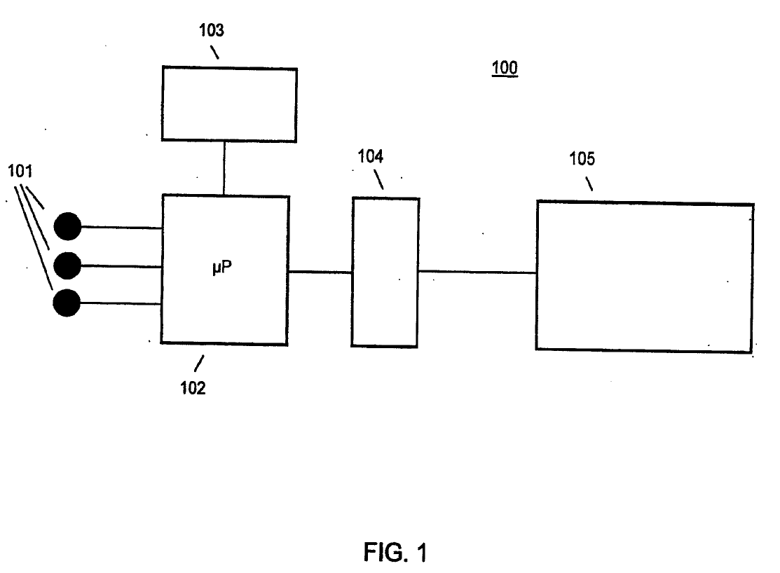

FIG. 1 shows a simplified block diagram of an exemplary thermostat 100 according to one embodiment of the invention. Lifestyle activity comfort settings can be represented and selected by individual lifestyle activity comfort selection buttons 101. Microcomputer 102 is programmed to allow each lifestyle activity comfort selection button 101 to be preset to certain user selectable comfort choices.

The preset procedure can be a “radio preset” style of setting, very similar to setting a preset radio station on a car radio. Later button selections (lifestyle comfort choices) can be as equally simple as pushing a radio station button in the car radio analogy.

Microcomputer 102 can also be programmed to carry out standard thermostat functions as known in the art. Such standard functions include sensing temperature, usually by an electrical signal from an electronic temperature sensor (not shown in FIG. 1), formatting data for user display on a thermostat display 103, and controlling heating ventilation and air conditioning (HVAC) equipment 105 via an electrical interface 104, generally including relays or electronic switches. Display 103 can also include a plurality of touch sensitive buttons. In some embodiments, some of the plurality of touch sensitive buttons on display 103 can include lifestyle activity comfort selection buttons 101. Since in this embodiment, lifestyle activity comfort selection buttons 101 are directly on the display 103, display 103 can also include labels on display 103 on or near each tough sensitive lifestyle activity comfort selection button 101 having text and/or a symbol corresponding to each lifestyle activity comfort choice selection. It is contemplated that in some embodiments, there could be additional user defined lifestyle activity comfort selection buttons 101 having corresponding user settable lifestyle activity comfort selection button labels.

In the past, user interaction with a thermostat has been in terms of temperature or temperature and time. For example, a user interaction with the most simple of common electronic thermostats involves pressing an up or down button to raise or lower the temperature in a room. In more sophisticated programmable thermostats, a user typically pre-programs the thermostat to hold a certain temperature programmed to occur at a certain time of day. In a home setting, for example, many homeowner users set their programmable thermostats to lower temperatures at their usual bed time, higher temperatures at their usual waking time, and then lower temperatures at a time they typically leave each weekday for work. Some home owners or business employees daunted by the complexity of many modern programmable thermostats have abandoned programming all together and advance the setpoint temperature up or down by multiple presses of the temperature up or down temperature control buttons. Also, persons with sight impairment, and persons who cannot, or simply do not want to, understand thermostat programming, often make use of only the temperature up and down buttons. Yet another group of mentally challenged users, otherwise able to function completely independently in life, are only able to effectively use conventional up and down thermostat temperature control buttons.

In a new method of interaction with a thermostat, it has been realized that personal interaction with a thermostat can be better achieved by providing selections that represent lifestyle activity comfort settings. That is, typically a desire to interact with a thermostat reflects a choice of a lifestyle activity made at about that moment. While time might be one of the factors that motivated the choice, e.g. time to go to work, it is not the time itself per se that drives the desire to change the thermostat. It is the lifestyle activity choice made at about that moment that most often causes a user to interact with a thermostat. Having made this realization, a thermostat has been developed that can allow a user to interact with it simply by pressing a lifestyle activity comfort selection button 101.

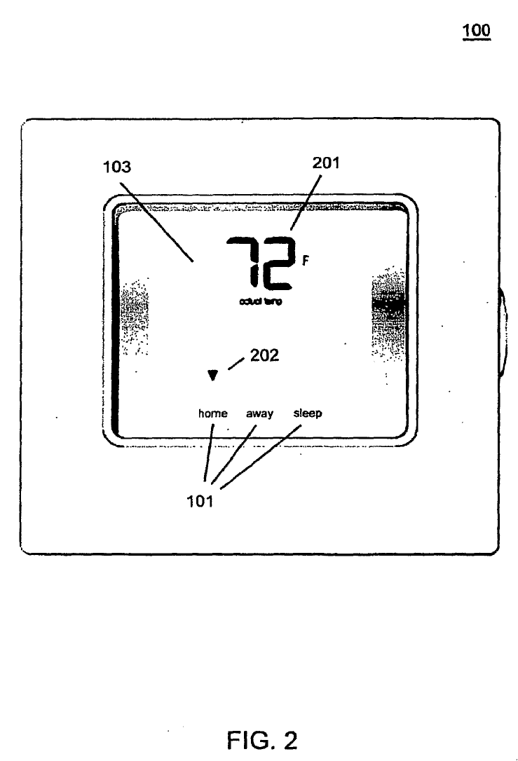

According to one embodiment of a thermostat 100 according to the invention as shown in FIG. 2, a lifestyle activity thermostat can offer three lifestyle activity comfort selection buttons 101, “home”, “away”, and “sleep”. While thermostat 100 conveniently indicates the ambient temperature 201 on display 103, a user of a lifestyle activity thermostat typically is concerned only with the lifestyle activity comfort selection buttons 101. For example, in the case of a young couple where both persons work at an office, on waking, one of the persons can tap (push) the home button, bringing the home comfort to the “home” preset comfort level. On leaving for work, again one of the persons, usually the last to leave for work, taps the “away” button for energy savings related to the “away” preset comfort settings. At the end of the workday, the first person home, once again taps the home button to restore the “home” preset comfort levels. And, finally on retiring to bed, a person taps the “sleep” button to set the controlled HVAC system 105 for the energy savings “sleep” preset comfort settings.

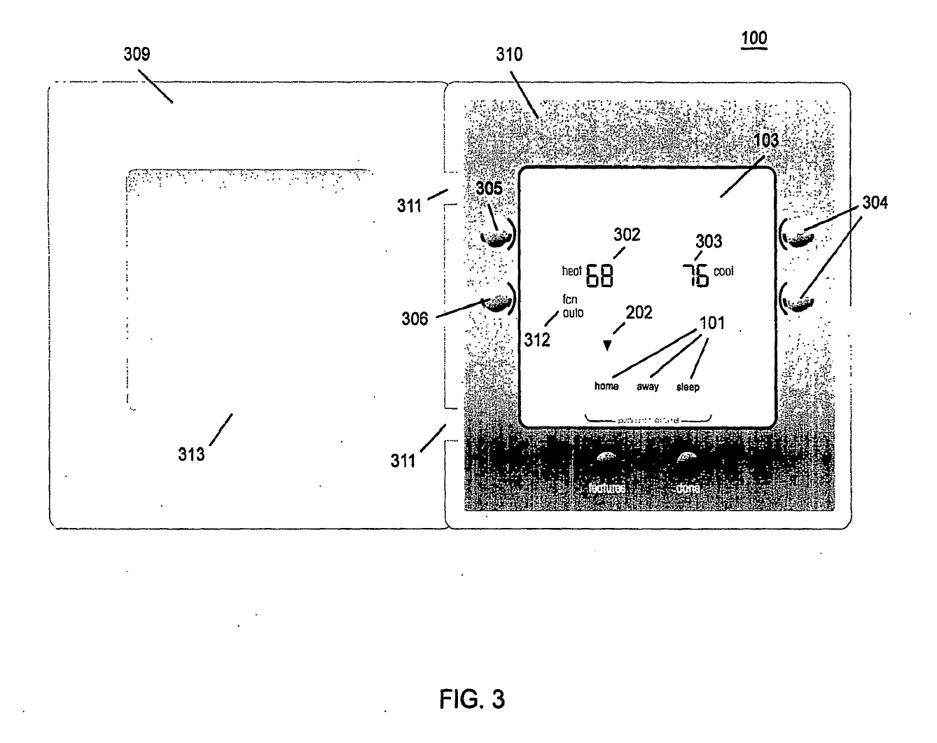

As shown in FIG. 3, the exemplary thermostat of FIG. 2, can be manufactured with a cover 309 that can open by hinges 311, revealing other thermostat setting buttons on an internal panel 310. Such buttons can provide for an initial presetting of the three exemplary lifestyle activity comfort selection buttons 101, as well as for more conventional thermostat operations as desired. For example, mode button 305 can be used to access a heat setpoint 302 and a cool setpoint 303. In one exemplary preset method, a user can select a heat and cool setpoint, then hold down the “radio type” lifestyle activity comfort selection button 101 corresponding to those settings for a brief period of time (e.g. three seconds) until the preset comfort settings for that lifestyle activity comfort selection button 101 are accepted as indicated by a blink of one or more indications on display 103 and/or an audible beep. The preset process can be repeated for each lifestyle activity comfort selection button 101, until all of the lifestyle activity comfort selection buttons 101 are preset. Such presetting, as in the case of a car radio, only need be done once, typically at the time of installation or move in.

It should also be noted that the lifestyle comfort choice thermostat can be operated as a more conventional thermostat as desired by use of, for example, a mode button 305 that can select a fully manual mode with conventional temperature selection. Microcomputer 102 (FIG. 1) can be factory programmed (through microcomputer firmware) to automatically return to the lifestyle comfort choice mode if one of the lifestyle activity comfort selection buttons 101 are pressed while the thermostat is in its fully manual mode.

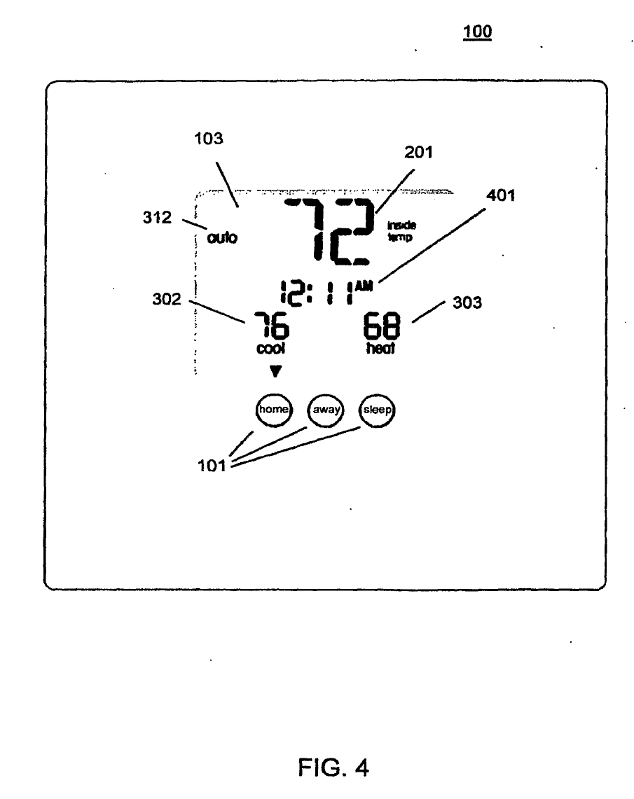

In another embodiment of a lifestyle comfort choice thermostat as shown in FIG. 4, the inventive lifestyle activity comfort choices can be added to a conventional programmable thermostat having a clock function 401. Here, the thermostat can be operated exactly as earlier described with regard to FIG. 2 and FIG. 3, or the thermostat can be completely programmed with settings corresponding to time of day and then operation can be supplemented by use of the lifestyle activity comfort selection buttons 101. For example, in this embodiment, thermostat 100 might have been programmed, to be in an energy savings configuration at 3 PM in the afternoon when no one would typically be home. However, a person coming home earlier than expected, can simply press the “home” button on returning home to restore the “home” comfort preset settings. Similarly, a person going to bed early can simply press or tap the “sleep” button without regard to any of the programmed time of day operation of a programmable thermostat 100. Or, a sight challenged person, waking early can simply press the first button in the lower left (“home”) without needing to wear their glasses to read display 103.

Opening the cover of the programmable thermostat 100 of FIG. 4 can reveal the standard programming buttons of a conventional programmable thermostat as well as the new lifestyle activity comfort selection buttons 101. Lifestyle activity comfort selection buttons 101 can be preset using a mode button 305 and temperature up and down buttons 304 as previously described. Conventional programming can be done by use of schedule button 501, period button 502, mode button 305, cancel button 507, and done button 506. These conventional buttons are merely exemplary of function buttons that can also be used in conventional ways to program a standard programmable thermostat 100. However, it is only necessary to preset the lifestyle activity comfort selection buttons 101 to use thermostat 100 according to the inventive method. Thus, programmable thermostat 100 can still be completely functional as a thermostat when interacted with by a user, exclusively through the new lifestyle activity comfort selection buttons 101, even where no programming of the conventional programmable thermostat time periods has been done.

In still other embodiments of a lifestyle comfort choice thermostat as shown in FIG. 2 to FIG. 4, i.e. a lifestyle comfort choice thermostat with or without a time-temperature programmable clock functionality, can further include an infra-red (“IR”) and/or radio receiver for remote control of a lifestyle comfort choice thermostat 100. In another application, “Universal Thermostat Expansion Port”, Ser. No. PCT/US06/49616, filed 29 Dec. 2006, and assigned to the Carrier Corporation, a thermostat having an IR or radio receiver was described. The PCT/US06/49616 application is hereby incorporated by reference in its entirety. A thermostat 100 can have an IR receiver and/or radio as a “plug in” receiver module or permanently installed in a non removable fashion, e.g. as part of a main thermostat printed circuit board assembly.

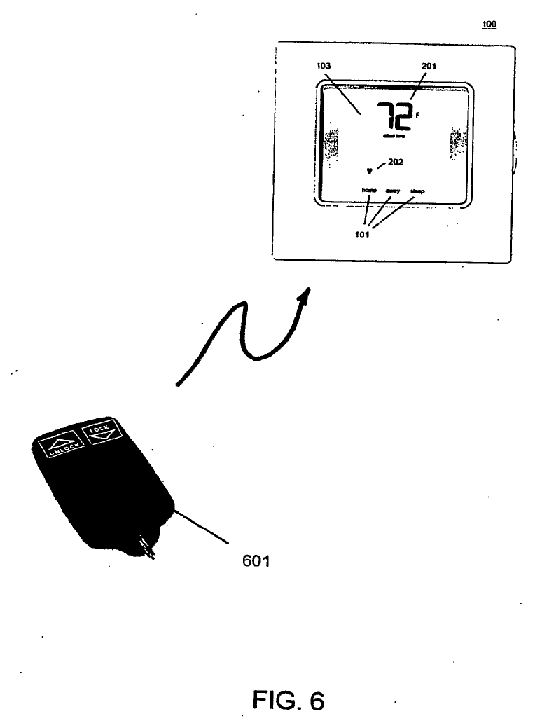

FIG. 6 shows one exemplary embodiment of a thermostat 100 having a radio receiver configured to receive radio commands sent from a typical remote car lock/unlock key chain device, car key remote 601, used to remotely lock and unlock one or more doors of an automobile. In the exemplary embodiment shown in FIG. 6, the lifestyle comfort choice thermostat 100 having a suitable radio receiver to receive signals from car key remotes 601, can recognize at least a distinguishing code and a lock and unlock signal from each car key remote 601 so that each car key remote 601 can be associated with a personal preference configuration setup and stored within lifestyle comfort choice thermostat 100. Such setups can range in complexity from two temperatures associated with each individual for the “home”, “away” Lifestyle activity comfort selection buttons 101 to full programming information including time-lifestyle pairs or conventional time-temperature pairs. A person entering the home and having one of the car key remotes 601 previously setup with a lifestyle comfort choice thermostat 100 can be used to signal the “home” preference for that car key remote 601 when, e.g. the “unlock” button is pressed. On leaving the home, pressing the “lock” button can cause a lifestyle comfort choice thermostat 100 to choose the “away” mode, setting an “away” preference for that car key remote 601. Where several car key remotes 601 are preprogrammed into a lifestyle comfort choice thermostat 100, there can be a prioritization of the car key remotes 601, such that if a second car key remote 601 signals to lifestyle comfort choice thermostat 100 a “unlock” or “home” signal, lifestyle comfort choice thermostat 100 can maintain the most recent “home” selection, or update to the second car key remote 601 user's preferences if they have been set as having a higher priority. In most, but not necessarily all such installations, the local lifestyle activity comfort selection buttons 101 on a lifestyle comfort choice thermostat 100 would typically have the highest priority, overriding any most recent “unlock” or “lock” signals from any car key remotes 601.

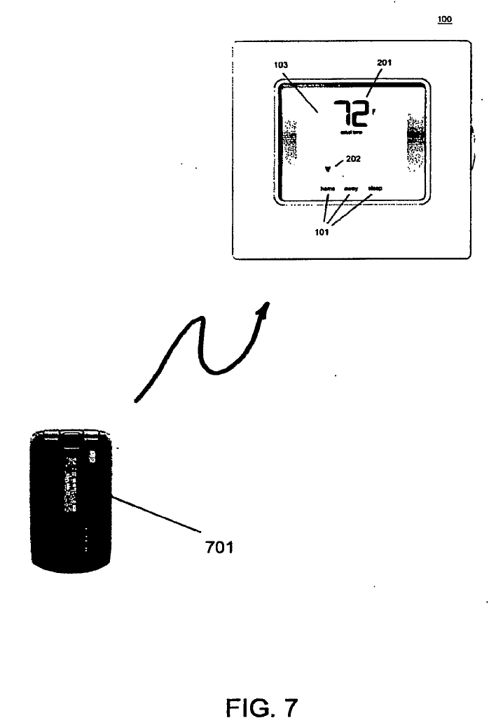

FIG. 7 shows yet another exemplary embodiment of a lifestyle comfort choice thermostat 100 configured to react to the presence of Blue Tooth™, Zigbee™, or other radio frequency (“RF”) identifying signal from a cell phone 701 that can be used by lifestyle comfort choice thermostat 100 to uniquely identify an individual's presence in the space and the individual's preset temperature preferences. In the case of a lifestyle comfort choice thermostat 100 these preferences can correspond, as in the previous example, to that individual's choice of temperatures for the “home” and “away” lifestyle activity comfort selection buttons 101. In the cell phone embodiment, thermostat 100 can detect the presence of a cell phone 701 in a home, office, or other occupied space and can set a corresponding “home” temperature selection for the individual's preferences associated with that cell phone 701. On departing the space, the lifestyle comfort choice thermostat 100 can register a loss of an identifying signal from the cell phone of the departing individual and set a corresponding “away” setting for that individual. In buildings or households using such a cell phone controlled lifestyle comfort choice thermostat 100, priorities can be set for which cell phones dominate, or “call” the setting for any given combinations of detected and pre-registered cell phones 701. Any cell phones remaining in the space can override the departure of an individual's cell phone, even if that cell phone had a higher priority, precluding a return to an “away” setting where a space is still occupied by other remaining individuals. Also as in the car key remote 601 example, a lifestyle comfort choice thermostat 100 can typically, but not necessarily, assign the highest priority to physical controls such as local lifestyle activity comfort selection buttons 101, manually accessible on the lifestyle comfort choice thermostat 100.

While the previous two remote controlled lifestyle comfort choice thermostats 100, as show in FIG. 6 and FIG. 7, have been described in terms of car key remotes 601 or cell phones 701, it can be appreciated that any form of remote IR or radio device that can transmit a unique identifier to a lifestyle comfort choice thermostats 100 can be used. Similarly, while a lifestyle comfort choice thermostat 100 might have remotely controlled settings corresponding to lifestyle activity comfort selection buttons 101, it can also be appreciated that other simpler thermostats having settable parameters, even as simple as a single temperature setting, could be so configured to be responsive to car key remotes 601 or cell phones 701. In other words, thermostat remote automatic sensing of individuals using IR or radio technologies can be implemented and practiced with most if not all types of thermostats so configured to be responsive to unique remote control devices.

Most embodiments of thermostat 100 according to the invention can also accomplish “auto changeover” between heating and cooling (when available). Such functionality eliminates the need to manually switch between heating and cooling as was the case with many early electronic thermostats. For example, in a desert climate, heat might be required to satisfy a “home” comfort setting in the morning, while cooling is needed to satisfy that same “home” preset in the afternoon. With auto changeover, lifestyle activity comfort selection buttons 101 can accomplish complete comfort control with no further user intervention.

An HVAC system corresponding to HVAC system 105 can include a gas, electric, solar, or oil fired furnace used with liquid (e.g. water) or forced air heating systems, an evaporative or coolant based air conditioner system, a heat pump system, or any other controllable home or commercial building comfort system including comfort systems having a heating unit and/or a cooling unit that causes heating and/or cooling of an indoor space in a home, office building, or other enclosed space.

It should also be noted that while the exemplary embodiments of thermostat 100 have been shown with three lifestyle activity comfort selection buttons 101, any number of additional lifestyle activity comfort selection buttons 101 can be added. It is also contemplated that lifestyle activity comfort selection buttons 101 could be mechanically configured to accept user lifestyle activity comfort choice labels to reflect customized lifestyle activity comfort selections.

The term “microcomputer”, as'used in reference to microcomputer 102, is defined herein as synonymous with, and interchangeable with, “microprocessor”, “microcontroller”, and any other integrated devices, such as “digital signal processor” (DSP) chips and “field programmable logic arrays” (FPGA) which can be programmed to perform the functions of a microcomputer.

While the present invention has been particularly shown and described with reference to the preferred mode as illustrated in the drawing, it will be understood by one skilled in the art that various changes in detail may be effected therein without departing from the spirit and scope of the invention as defined by the claims.

We claim:

1. A thermostat for controlling a HVAC system comprising:
at least one microcomputer;
an interface circuit, said interface circuit electrically coupled to said microcomputer, said interface circuit also electrically coupled to a HVAC system;
a display, said display electrically coupled to said microcomputer, said display to indicate a plurality of comfort settings; and
at least three thermostat user interface buttons, said at least three thermostat user interface buttons electrically coupled to said at least one microprocessor, wherein said at least one microcomputer is programmed to accept a preset lifestyle activity comfort level corresponding to each of said at least three thermostat user interface buttons, each of said at least three user interface thermostat buttons labeled with a corresponding lifestyle activity comfort choice label, wherein the preset lifestyle activity comfort level corresponding to each of said at least three thermostat user interface buttons is accomplished using a “radio preset” style of setting, and operation of any one of the at least three user interface thermostat buttons causes the HVAC system to provide said preset lifestyle activity comfort level of said corresponding lifestyle activity comfort choice label.

2. The thermostat of claim 1, wherein said lifestyle activity comfort choice labels include “home”, “away”, and “sleep”.

3. The thermostat of claim 1, wherein said HVAC system includes a heating unit and a cooling unit.

4. The thermostat of claim 3, wherein said operation of any one of the at least three user interface thermostat buttons causes the HVAC system to provide said preset lifestyle activity comfort level by automatically using either said heating unit or said cooling unit as needed.

5. The thermostat of claim 1, wherein said operation of any one of the at least three user interface thermostat buttons causes a visible indication on said display, said indication showing which button of the at least three user interface thermostat buttons was selected.

6. The thermostat of claim 1, wherein said thermostat is a time programmable thermostat.

7. The time programmable thermostat of claim 6, wherein said operation of any one of the at least three user interface thermostat buttons causes said programmable thermostat to switch from a present programmed mode based on time to one of said preset lifestyle activity comfort levels corresponding to that button.

8. The time programmable thermostat of claim 7, wherein said time programmable thermostat returns to a next time programmed comfort level following said operation of any one of the at least three user interface thermostat buttons.

9. The thermostat of claim 1, wherein said display comprises a plurality of touch sensitive buttons wherein at least three of said plurality of touch sensitive buttons are configured as said at least three thermostat user interface buttons.

10. The thermostat of claim 9, wherein said at least three of said plurality of touch sensitive buttons include said corresponding lifestyle activity comfort choice label appearing on said display.

11. A method of selecting a comfort level comprising the steps of:
providing a thermostat having at least three user operable buttons, said user operable buttons labeled with a lifestyle activity comfort choice, each button corresponding to a lifestyle activity comfort choice label;
presetting at least one time, each of said user operable buttons labeled with a lifestyle activity comfort choice to a comfort level choice using a “radio preset” style of presetting;
selecting one of said user operable buttons labeled with a lifestyle activity comfort choice to operate to recall a preset comfort level choice corresponding to a present lifestyle activity choice; and
performing again the step of selecting one of said user operable buttons labeled with a lifestyle activity comfort choice to operate when another of said preset comfort level choices better corresponds to a present lifestyle activity choice, wherein said selection is made directly by reference to one of said lifestyle activity comfort choice labels.

12. The method of step of claim 11, wherein the step of providing comprises the step of providing a programmable thermostat having at least three user operable buttons, said user operable buttons labeled with a lifestyle activity comfort choice, each button corresponding to a lifestyle activity comfort choice label.

13. The method step of claim 12, wherein the step of providing comprises the step of providing a programmable thermostat having at least three user operable buttons, said user operable buttons labeled with a lifestyle activity comfort choice, each button corresponding to a lifestyle activity comfort choice label, wherein on a next successive time programmed comfort level, said next successive time programmed comfort level occurs and said thermostat returns to a time programmed mode.

14. A thermostat for controlling a comfort level in a building space comprising:
at least one microcomputer;
an interface circuit, said interface circuit electrically coupled to said microcomputer, said interface circuit also electrically coupled to a HVAC system;
a display, said display electrically coupled to said microcomputer, said display to indicate a plurality of comfort settings; and
a receiver coupled to said microcomputer, wherein said receiver reacts responsively to a signal indicating the presence of a person in the building space such that on detection of the presence of the person by said receiver, said thermostat sets a comfort level preferred by the person according to a preset comfort level.

15. The thermostat of claim 14, wherein said receiver is an infra-red (“IR”) receiver and said signal originates from an IR remote sending a unique identifier.

16. The thermostat of claim 14, wherein said receiver is a radio frequency (“RF”) receiver and said signal originates from an RF transmitter sending a unique identifier.

17. The thermostat of claim 16, wherein said RF transmitter is a cell phone.

18. The thermostat of claim 17, wherein said RF transmitter is a cell phone and said unique identifier is sent by a Bluetooth or Zigbee transmission.

19. The thermostat of claim 16, wherein said RF transmitter is a car key remote.

20. The thermostat of claim 19, wherein a car key remote unlock button causes said thermostat to enter a home lifestyle comfort mode and a car key remote lock button causes said thermostat to enter an away lifestyle comfort mode.
